(19) United States
(12) Patent Application Publication
(10) Pub. No.: US 2007/0117485 A1
(43) Pub. Date: May 24, 2007

(54) Laminated film

(75) Inventors: Yoshimasa Sakata, Osaka (JP); Yuuzou Akada, Osaka (JP); Tadaaki Harada, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 10/578,308

(22) PCT Filed: Nov. 5, 2004
(86) PCT No.: PCT/JP04/16415

§ 371 Date: May 4, 2006

(30) Foreign Application Priority Data
Nov. 6, 2003 (JP) 2003-377151

(51) Int. Cl. B32B 17/02; B32B 5/26; B32B 17/04

(52) U.S. Cl. 442/180; 442/268; 442/189; 442/172

(57) ABSTRACT

In the present invention, there is provided a laminated film that is excellent in terms of mechanical strength and low coefficient of thermal expansion. According to the present invention, there is provided a laminated film, which is characterized in that it comprises a resin sheet having a cured resin layer containing glass cloth and a polarizing plate laminated on the resin sheet, in which any one of weft yarn and warp yarn of the glass cloth is oriented at an angle of 5 degrees or less relative to an absorption axis of the polarizing plate.

### FIELD OF THE INVENTION

The present invention relates to a laminated film used as a laminated body of a substrate and a polarizing plate, of a liquid crystal display device, an organic electroluminescence display device or the like.

### BACKGROUND OF THE INVENTION

In the fields of image display devices, such as liquid crystal display devices and organic electroluminescence display devices, it is proposed to use plastic substrates in place of conventional glass substrates for progress in making displays lightweight, low-profile and high impact.

Whilst substrates of the above type are required to have a low coefficient of thermal expansion, plastic substrates may pose a problem of causing misalignment when forming, for example, electrodes or color filters, due to thermal shrinkage and expansion, since plastic has a higher coefficient of linear expansion than glass.

Although those of various active matrix driving types are recently used especially in the field of liquid crystal display devices thanks to the excellent display quality compared with passive matrix driving types, the above problem is more significant in the liquid crystal display devices of the active matrix driving types because they are required to have a lower coefficient of thermal expansion than the passive matrix driving types.

Another problem associated with plastic substrates is that the mechanical strength thereof is relatively low.

In light of the above problems, there is proposed a resin sheet for a substrate that includes a cured resin layer containing glass cloth, which layer is formed by impregnating glass cloth with a pre-cured resin, molding it into a sheet and curing the same, in which the glass cloth is formed by weaving glass fibers into cloth (Patent documents 1, 2 referred below).
Patent Document 1: Official Gazette of Japanese Patent Application Laid-open No. 2003-50384
Patent Document 2: Official Gazette of Japanese Patent Application Laid-open No. Hei-11-2812

### SUMMARY OF THE INVENTION

### Problems to be Solved by the Invention

However, the above conventional resin sheet may cause stress birefringence in glass fibers due to curing shrinkage of resin or cooling shrinkage after molded, whilst it is excellent in terms of mechanical strength and low coefficient of thermal expansion. This stress birefringence may cause a problem of deteriorating the display quality of an image display device, and more specifically causing occurrence of light leakage in a black display mode of, for example, a liquid crystal cell or the like prepared by the use of a laminated film that is formed by laminating a polarizing plate on the resin sheet.

Accordingly, it is an object of the present invention to provide a laminated film that is excellent in terms of mechanical strength and low coefficient of thermal expansion, and is capable of achieving excellent display quality of an image display device.

### Means of Solving the Problems

The present inventors made intensive studies in order to solve the above problem, found that when any one of warp yarn and weft yarn of glass cloth is oriented at an angle of 5 degrees or less relative to an absorption axis of a polarizing plate, practically no light leakage is observed, and thus achieved the present invention.

Specifically, in the present invention, there is provided a laminated film that is made up of a resin sheet having a cured resin layer containing glass cloth and a polarizing plate laminated on the resin sheet, in which any one of weft yarn and warp yarn of the glass cloth is oriented at an angle of 5 degrees or less relative to an absorption axis of the polarizing plate.

According to the present invention, the cured resin layer contains the glass cloth so that it is excellent in terms of mechanical strength and low coefficient of thermal expansion as compared with a resin layer consisting of a resin alone.

Furthermore, any one of weft yarn and warp yarn of the glass cloth is oriented at an angle of 5 degrees or less relative to an absorption axis of the polarizing plate, so that it is possible to significantly reduce light leakage, thus achieving excellent display quality of, for example, a liquid crystal display device or the like.

### EFFECTS OF THE INVENTION

As described above, a laminated film of the present invention is excellent in terms of mechanical strength and low coefficient of thermal expansion, as well as enabling an image display device to have excellent display quality.

### BRIEF DESCRIPTION OF THE DRAWINGS

FIG. 1 is a cross sectional view illustrating a laminated film according to one embodiment.

FIG. 2 is a top view of a laminated film according to one embodiment, illustrating a polarizing plate with a partly broken-out section.

FIG. 3 is a cross sectional view illustrating a laminated film according to one embodiment.

### DESCRIPTION OF THE REFERENCE CODES

1: resin sheet

2: glass cloth

3: polarizing plate

4: cured resin layer

7: hard-coat layer

8: gas barrier layer

### BEST MODE FOR CARRYING OUT THE INVENTION

Description will be made for the embodiments of the present invention with reference to the drawings.

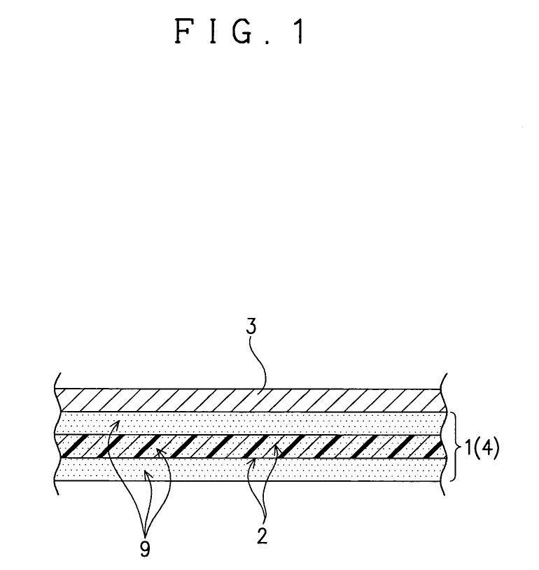

FIG. 1 is a cross sectional view illustrating one embodiment of the present invention.

A laminated film of the present invention is, as illustrated in FIG. 1, made up of a resin sheet 1 and a polarizing plate 3, which are laminated to each other.

The resin sheet 1 has a cured resin layer 4 containing glass cloth 2; the cured resin layer 4 is made up of the glass cloth 2 and a cured resin material 9; and specifically the resin sheet 1 is formed by integral molding of these members.

The glass cloth 2 is embedded in the cured resin material 9, which forms the cured resin layer 4, while being laid along the surface direction (or in parallel to surface direction) of the cured resin layer 4.

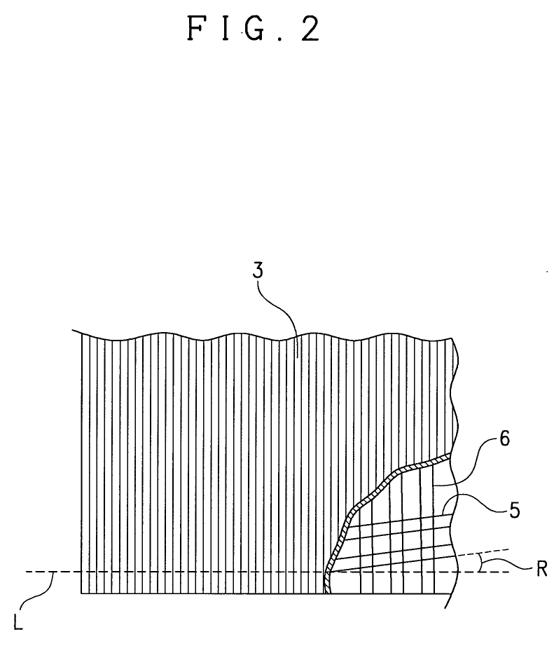

FIG. 2 is a top view of a laminated film according to one embodiment, illustrating a polarizing plate with a partly broken-out section.

As illustrated in FIG. 2, in a laminated film of the present invention, any one of weft yarn 5 and warp yarn 6, of the glass cloth 2 is oriented at an angle R of 5 degrees or less relative to an absorption axis L of the polarizing plate 3.

Herein, by the angle R at which any one of the weft yarn 5 and the warp yarn 6 is oriented relative to the absorption axis L is meant an angle R when viewed from a direction orthogonal to the surface of the laminated film, as illustrated in FIG. 2.

In the present invention, the resin sheet may be obtained by, for example, impregnating glass cloth with a pre-cured resin, then molding it into a sheet and curing the same. As a curing technique, a heat curing, ultraviolet curing, electron beam curing or other curing technique may be used alone or in combination. Of them, it is preferable to use a heat curing technique, since a cured mold by this technique has excellent thermal resistance.

As a matrix resin for forming the cured resin material, a thermoplastic resin such as a polyester resin, a polyethylene resin, a polystyrene resin, a polycarbonate resin, a polyamide resin, a polyacetal resin and a polyphenylene sulfide resin, and a curing resin such as a phenol resin, an epoxy resin, a vinylester resin, a polyimide resin, a melamine resin and a urea resin may be used alone or in combination.

Of those resins, a curing resin and particularly an epoxy resin, which remains in a liquid state when in a pre-cured state, is preferable, since air bubbles hardly remain after it is molded and cured.

As an epoxy resin, it is possible to use hitherto known epoxy resins, which include bisphenol types such as bisphenol A type, bisphenol F type, bisphenol S type, and hydrogenated epoxies derived from these; novolak types such as phenol novolak type and cresol novolak type; nitrogen-containing cyclic types such as triglycidyl isocyanurate type and hydantoin type; alicyclic types; aliphatic types; aromatic types such as naphthalene type; low-water-absorption types such as glycidyl ether type and biphenyl type; dicyclo types such as dicyclopentadiene type; ester types; etherester types; and modifications of these. Of these epoxy resins, preferred epoxy resins from the standpoints of unsusceptibility to discoloration, etc., are bisphenol A type epoxy resin, alicyclic type epoxy resin, triglycidyl isocyanulate type epoxy resin and dicyclopentadiene type epoxy resin. These epoxy resins may be used alone or in combination of two or more thereof. More illustratively, from the standpoints of the capability of exhibiting heat resistance, toughness and low birefringence with good balance, the combination of the dicyclopentadiene type epoxy resin and the alicyclic type epoxy resin is preferable.

An example of the bisphenol A type epoxy resin includes an epoxy resin represented by the following formula (1), in which n is, for example, 0 to 2.

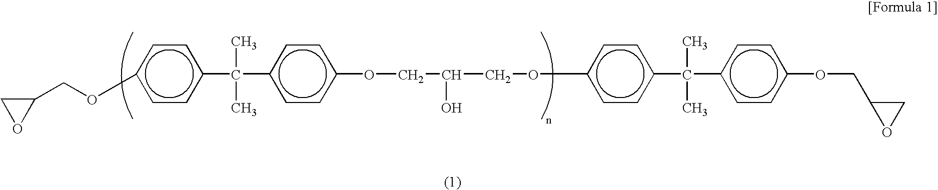

Examples of the alicyclic type epoxy resin include 3,4 -epoxycyclohexylmethyl-3,4-epoxycyclohexanecarboxylate represented by the following formula (2), and those represented by the following formula (3). In the formula (3), n represents an integer of 1 to 20 and R represents alkyl group.

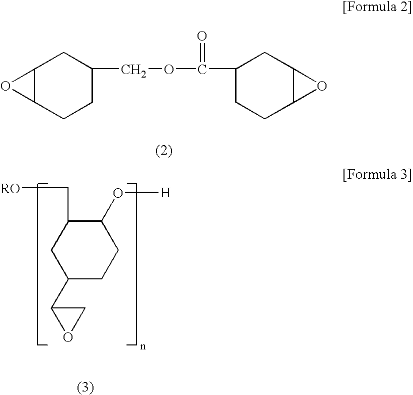

Examples of the dicyclopentadiene type epoxy resin (an epoxy resin having the skeleton of dicyclopentadiene) include epoxy resins respectively represented by the following formula (4), (5). In the formula (5), n represents an integer of 1 to 3.

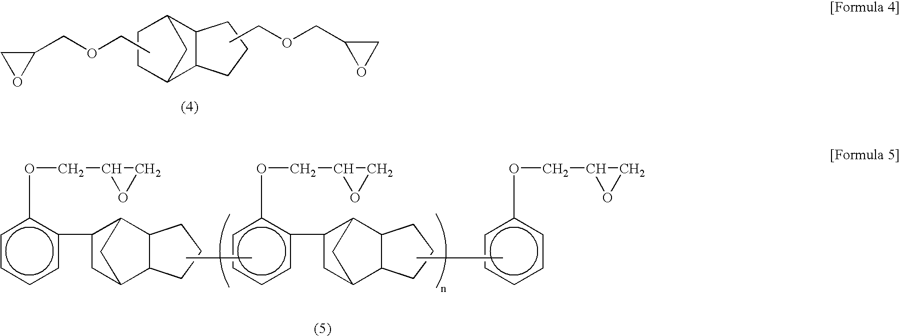

Of the aforesaid epoxy resins, particularly preferable is the epoxy resin represented by the formula (4) or (5). A reason is that the use of these resins makes it possible to control the thicknesswise retardation of a cured resin layer to a small value. When the thicknesswise retardation is small, it is possible to suppress light leakage in an oblique direction in a black display mode when the laminated film is used in a liquid crystal display device. Thus, the display characteristics are further improved.

From the standpoint of improving, for example, the flexibility or strength of a cured resin layer to be formed, the epoxy resin preferably has an epoxy equivalent of 100 to 1000 (g/eq) and a softening point of 120° C. or below, and more preferably, an epoxy equivalent of 150 to 500 (g/eq) and a softening point of 80° C. or below. The epoxy resin preferably remains in a liquid state at ordinal temperature (e.g., 5 to 35° C.).

For forming a cured resin layer, it is preferable to use a two-component epoxy resin that remains in a liquid state at a temperature equal to or lower than the temperature at which the coating is carried out, or particularly at ordinal temperature, since it is excellent in spreading property and coatability.

In a cured resin layer of the present invention, the proportion of the cured resin material (a portion of the cured resin layer excluding the glass cloth) is, for example, from 20 to 80 wt. %, preferably from 25 to 75 wt. % and more preferably from 30 to 70 wt. %. Meanwhile, the proportion of the glass fiber in the cured resin layer is, for example, from 20 to 80 wt. %, preferably from 25 to 75 wt. % and more preferably from 30 to 70 wt. %.

The cured resin material may be mixed with various types of additives other than resins according to needs and circumstances.

Examples of the additives include curing agents, curing accelerators, age resistors, modifying agents, surfactants, colorants, pigments, discoloration inhibitors, UV absorbers and photoinitiators.

The resin is contained in the cured resin material usually in the range from 30 to 100 wt. %, preferably in the range from 40 to 90 wt. % and more preferably in the range from 40 to 80 wt. %.

The mixing ratio of each component in the cured resin material is adjusted to allow glass cloth to have a refractive index different by 0.01 or less from that of the cured resin material for the purpose of retaining the transparency after curing.

Examples of the curing agent include without limitation organic acid compounds such as tetrahydrophthalic acid, methyltetrahydrophthalic acid, hexahydrophthalic acid and methylhexahydrophthalic acid, and amine compounds such as ethylenediamine, propylenediamine, diethylenetriamine, triethylenetetramine, amine adducts thereof, methaphenylenediamine, diaminodiphenylmethane and diaminodiphenylsulfone. These may be used alone or in combination of two or more thereof.

Further examples of the curing agent include amide compounds such as dicyandiamide and polyamide, hydrazide compounds such as dihydrazide, imidazole compounds such as methylimidazole, 2-ethyl-4-methylimidazole, ethylimidazole, isopropylimidazole, 2,4-dimethylimidazole, phenylimidazole, undecylimidazole, heptadecylimidazole and 2-phenyl-4-methylimidazole, imidazoline compounds such as methylimidazoline, 2-ethyl-4-methylimidazoline, ethylimidazoline, isopropylimidazoline, 2,4-dimethylimidazoline, phenylimidazoline, undecylimidazoline, heptadecylimidazoline and 2-phenyl-4-methylimidazoline, phenol compounds, urea compounds and polysulfide compounds.

In addition, acid anhydrides and the like may be used as the curing agent, and these acid anhydrides are preferably used from the standpoints of, for example, discoloration inhibiting characteristics. Examples of these acid anhydrides include phthalic anhydride, maleic anhydride, trimellitic anhydride, pyromellitic anhydride, nadic anhydride, glutaric anhydride, tetrahydrophthalic anhydride, methyltetrahydrophthalic anhydride, hexahydrophthalic anhydride, methylhexahydrophthalic anhydride, methylnadic anhydride, dodecenylsuccinic anhydride, dichlorosuccinic anhydride, benzophenonetetracarboxylic anhydride and chlorendic anhydride. Of these acid anhydrides, it is preferable to use colorless or pale yellow acid anhydride curing agents having a molecular weight of from about 140 to about 200, such as phthalic anhydride, tetrahydrophthalic anhydride, hexahydrophthalic anhydride, methylhexahydrophthalic anhydride or methyl nadic anhydride.

When an epoxy resin is used as a resin that forms the cured resin material, and when an acid anhydride curing agent is used as a curing agent, although no limitation is intended on the amount of the curing agent to be added in the epoxy resin, an acid anhydride is added in an amount of, for example, preferably from 0.5 to 1.5 equivalents, and more preferably from 0.7 to 1.2 equivalents, per equivalent of epoxy group in the epoxy resin. With the acid anhydride curing agent added in an amount of 0.5 equivalents or more, it is possible to make the color tint after curing significant, and with being 1.5 equivalents or less, satisfactory moisture resistance can be kept. In a case where a different curing agent is used, or two or more types of the curing agents are used, it is possible to mix them according to the aforesaid equivalent ratio.

Examples of the curing accelerator include without limitation tertiary amines, imidazoles, quaternary ammonium salts, quaternary phosphonium salts, organic metal salts, phosphorus compounds and urea compounds, and of them, tertiary amines, imidazoles and quaternary phosphonium salts are preferable. These curing accelerators may be used alone or in combination of two or more thereof.

The amount of the curing accelerator to be added in the cured resin material is not limited to a specific amount, but is determined depending on the type of the resin or the like. For example, when an epoxy resin is used, the curing accelerator is added in an amount of preferably from 0.05 to 7.0 parts by weight, and more preferably from 0.2 to 3.0 parts by weight, per 100 parts by weight of the epoxy resin. With the curing accelerator added in an amount of 0.05 parts by weight or more, satisfactory curing acceleration effect can be produced, and when in an amount of 7.0 parts by weight or less, it is possible to make the color tint after curing significant.

Examples of the age resistor include without limitation phenol compounds, amine compounds, organic sulphur compounds, phosphine compounds and other hitherto known compounds.

Examples of the modifying agent include without limitation glycols, silicones, alcohols and other hitherto known compounds.

Examples of the surfactant include various types of surfactants such as silicone, acrylic or fluorinated surfactants. Of them, silicone surfactant is preferable. These surfactants are added to smoothen the surface of a resin sheet when the resin sheet is to be formed by, for example, curing a resin in contact with air.

The resin sheet, which has a cured resin layer containing glass cloth, may further have a separate layer formed only by a cured resin material with no glass cloth contained.

In the cured resin layer, the absolute value of the difference in average refractive index between the cured resin material and the glass cloth is preferably from 0 to 0.01, more preferably from 0 to 0.008, and still more preferably from 0 to 0.006. The absolute value is preferably equal to or less than 0.01, since interface scattering between the glass cloth and the cured resin material can be satisfactorily suppressed, the haze of a resin sheet can be decreased, and hence the original transparency of the cured resin material can be satisfactorily maintained.

Herein, the average refractive indices of glass cloth and a cured resin material can be measured independently each other, for a sheet of only glass cloth and a sheet of only a cured resin material separately formed, by use of an Abbe refractometer at 25° C. and 589 nm. The average refractive index represents an average value of nx, ny and nz. In this, nx, ny and nz respectively represent refractive indices in directions of an X axis, a Y axis and a Z axis in each sheet. The X axis is an axis that gives a maximum in-plane refractive index in each sheet, the Y axis is an in-plane axis perpendicular to the X axis, and the Z axis is an axis perpendicular to the plane.

The average refractive indices of the cured resin material and the glass cloth each are preferably 0.01 or lower.

The cured resin material may have an average refractive index of 0.01 or lower by, for example, appropriately adjusting the ratio of each additive (e.g., a curing agent, etc.) mixed in a resin.

The resin sheet preferably has a coefficient of linear expansion being equal to or less than 3.00×10⁻⁵/° C. at a temperature from 25° C. to 160° C. With a value being equal to or less than this value, it is possible to satisfactorily suppress misalignment or the like due to thermal expansion, and hence more easily form a color filter, etc., in a case where a laminated film of the present invention is used as, for example, a liquid crystal cell substrate, and a color filter, an electrode, etc., are formed thereon. The coefficient of linear expansion is more preferably equal to or less than 2.00×10⁻⁵/° C., and still more preferably equal to or less than 1.5×10⁻⁵/° C.

The coefficient of linear expansion is determined by obtaining a TMA measured value by the TMA method specified in JIS K-7197 and substituting it into the following expression. In the following expression, ΔIs(T₁) and ΔIs(T₂) represent TMA measured values (μm) respectively obtained at a temperature T₁(° C.) and a temperature T₂(° C.), at which the measurement is carried out, and L₀ represents a length (mm) of an object to be measured, at a room temperature of 23° C.
Thermal expansion coefficient=[1/(L₀10³)]·[(ΔIs(T₂)−ΔIs(T₁))/(T₂−T₁)]

The resin sheet has a haze value of preferably 10% or lower, more preferably 3% or lower and still more preferably 2% or lower. The haze value is measured according to JIS K 7136. Specifically, the measurement is carried out by using a commercially available hazemeter (e.g., HM-150, trade name; manufactured by Murakami Color Research Laboratory).

Furthermore, the resin sheet has a light transmittance of preferably 85% or higher, more preferably 88% or higher and still more preferably 90% or higher. When the light transmittance is 85% or higher, it is possible to provide more crisp characters or images in various types of image display devices, and thus achieving more excellent display quality, when those image display devices each are assembled by using the resin sheet as a substrate of a liquid crystal cell, a substrate of an organic EL device, or the like. The light transmittance can be determined by measuring a total transmittance of light rays with a wavelength of 550 nm, using a spectrophotometer.

The in-plane retardation of each of the cured resin layer and a resin sheet is preferably 5 nm or smaller, more preferably from 0 to 3 nm, and still more preferably from 0 to 1 nm.

With the in-plane retardation being 2 nm or smaller, it is possible to further enhance the contrast of an image display device, and particularly the contrast in an oblique direction, and hence achieve excellent display quality, when used as a substrate of a liquid crystal cell or a substrate of an organic EL display device.

The thicknesswise retardation of each of the cured resin layer and a resin sheet is preferably 40 nm or smaller, more preferably from 0 to 20 nm, and still more preferably from 0 to 10 nm. With the thicknesswise retardation being 40 nm or smaller, it is possible to satisfactorily suppress the light leakage in an oblique direction, further enhance the contrast in an oblique direction and hence achieve more excellent display quality, when applied to an image display device, as mentioned above. In a case where the thicknesswise retardation is set at 40 nm or smaller, and particularly at 20 nm or smaller, it is particularly preferable to use, as a resin, an epoxy resin represented by the aforesaid formula (4) or (5).

The in-plane retardation (Δnd) and the thicknesswise retardation (Rth) are respectively represented by the following formula. In the following formula, nx, ny and nz respectively represent refractive indices in an X axis, a Y axis and a Z axis, of the cured resin layer, and d represents the thickness of the cured resin layer. Herein, the X axis is an axis that gives a maximum in-plane refractive index in the cured resin layer, the Y axis is an in-plane axis perpendicular to the X axis, and the Z axis represents an axis perpendicular to the plane. Each refractive index is a value measured by an Abbe refractometer at 25° C. and 589 nm.
Δnd=(nx·ny)·d
Rth=[{(nx+ny)/2}·nz]·d

At least one surface of the resin sheet on which surface the polarizing plate is not laminated is preferably smoothened. The thus smoothened surface makes it easier to form thereon an alignment film, a transparent electrode or the like in a case where it is used for example as a liquid crystal cell substrate. Specifically, the at least one surface preferably has a surface roughness (Rt) of, for example, 2 μm or smaller. In the present invention, the “surface roughness” represents a difference between a maximum value and a minimum value, which are obtained by measurement using a stylus type surface roughness meter (e.g., P-11, trade name; manufactured by KLA-Tencor Ltd.) under a condition of a long wavelength cut-off of 800 μm, a short wavelength cut-off of 250 μm, and an evaluation length of 10 mm.

The thickness of the cured resin layer in the resin sheet is not necessarily limited to a specific value, but is preferably in the range of, for example, from 20 to 800 μm. This is because when the thickness is 20 μm or more, it is possible to maintain satisfactory strength and stiffness; and when the thickness is 800 μm or less, it is possible to satisfactorily achieve low profile and light weight. The aforesaid thickness is more preferably from 30 to 500 μm and still more preferably 50 to 300 μm.

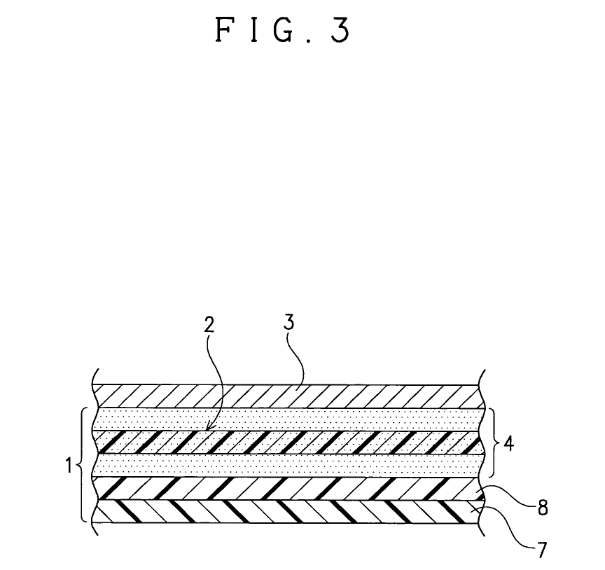

The resin sheet is preferably a laminated body further including, in addition to the cured resin layer containing glass cloth, at least one of a hard-coat layer, which is harder than the cured resin layer, and a gas barrier layer, which is more excellent in gas barrier properties than the cured resin layer. Particularly, as illustrated in FIG. 3, the resin sheet is preferably a laminated body including both a hard-coat layer 7 and a gas barrier layer 8 with the hard-coat layer 7 laminated as an outermost layer. With the hard-coat layer 7 laminated as an outermost layer, it is possible to improve abrasion resistance, etc., of the resin sheet. In various types of image display devices such as a liquid crystal display device, when moisture or oxygen passes through a liquid crystal cell substrate and enters the inside of the liquid crystal cell, the quality of a liquid crystal changes and bubbles are formed, which may cause deterioration in display quality. However, the gas barrier layer as laminated can prevent passing-through of gas such as moisture and oxygen. The hard-coat layer and the gas barrier layer may be laminated on either side or both may be laminated on each of both sides. However, it is preferable to laminate a hard-coat layer on at least one side, on which a polarizing plate is not laminated.

In a case where both a hard-coat layer and a gas barrier layer are laminated, the order, in which they are laminated, is not necessarily limited to a specific order; but it is preferable to laminate first a gas barrier layer and then a hard-coat layer onto a cured resin layer. Particularly, a hard-coat layer is preferably laminated as an outermost layer since it is excellent in impact resistance, chemical resistance, etc.

Examples of a material for forming the hard-coat layer include without limitation melamine resins, urethane resins, acrylic resins, silicone resins and the like. Further, for example, polyarylate resins, sulfone resins, amide resins, imide resins, polyether sulfone resins, polyether imide resins, polycarbonate resins, fluoro resins, polyolefin resins, styrene resins, vinylpyrrolidone resins, cellulose resins, acrylonitrile resins and the like may be mixed in those resins for use. Of them, urethane resins are preferably used, and urethane acrylate is more preferably used.

Although no limitation is intended, the thickness of the hard-coat layer is, for example, in the range from 0.5 to 50 μm, preferably from 1 to 8 μm, and still more preferably from 1.5 to 5 μm, from the standpoints of ease to remove and prevention of occurrence of cracking due to the removal, when manufacturing.

The gas barrier layer is categorized into, for example, an organic gas barrier layer and an inorganic gas barrier layer. Examples of a material for forming the organic gas barrier layer include without limitation materials with low oxygen-permeability, such as vinyl alcohol polymers such as polyvinyl alcohol, a partially saponified product thereof and ethylene vinyl alcohol copolymer, and polyvinylidene chloride. Of these materials, vinyl alcohol polymers are particularly preferably used from the standpoint of their high gas barrier properties.

From the standpoints of, for example, functionality in terms of transparency, prevention of coloration, gas barrier properties and the like, as well as reduction in thickness, flexibility of a resulting resin sheet and the like, the thickness of the organic gas barrier layer is, preferably 10 μm or smaller, more preferably from 2 to 10 μm, and still more preferably from 3 to 5 μm. In the resin sheet, with the thickness being 10 μm or smaller, a lower yellow color index (YI value) may be maintained, and with the thickness being 2 μm or greater, satisfactory gas barrier performance can be maintained.

Meanwhile, as a material for forming an inorganic gas barrier layer, for example, transparent materials such as silicon oxides, magnesium oxides, aluminum oxides, zinc oxides and the like may be used. Of these materials, silicon oxides and silicon nitrides are preferably used from the standpoints of, for example, their excellent gas barrier properties, adhesion to a substrate layer and the like.

Preferably, the silicon oxides have, for example, a ratio of the number of oxygen atoms to the number of silicon atoms of 1.5 to 2.0 for the following reason. That is, with this ratio, the inorganic gas barrier layer is improved further in terms of, for example, gas barrier properties, transparency, surface flatness, bending properties, membrane stress, cost, and the like. In the silicon oxides, the maximum value of the ratio of the number of oxygen atoms to the number of silicon atoms is 2.0.

The silicon nitrides preferably have a ratio (Si:N) of the number of nitrogen atoms (N) to the number of silicon atoms (Si) of 1:1 to 3:4.

Although no limitation is intended, the inorganic gas barrier layer has a thickness preferably in the range of, for example, from 5 to 200 nm. With the thickness being 5 nm or greater, for example, more excellent gas barrier properties can be obtained, and with the thickness being 200 nm or smaller, the inorganic gas barrier layer is improved also in terms of transparency, bending properties, membrane stress, and cost.

When a resin sheet of the present invention is a laminated body, its thickness, which varies depending on the number of layers laminated, is preferably for example in the range from 20 to 800 μm, more preferably in the range from 30 to 500 μm, and still more preferably in the range from 50 to 300 μm. When a resin sheet is a laminated body, only a single cured resin layer or two or more cured resin layers, with glass fiber embedded therein, may be contained in the thus arranged resin sheet.

In the present invention, by the glass cloth is meant cloth woven by using yarns made of glass fibers twisted together as weft yarn and warp yarn.

The glass cloth is woven generally with the weft yarn running at right angle to the warp yarn when viewed from the top.

For the weft yarn and the warp yarn, yarns formed by twisting about 100 to 800 continuous glass fibers (filaments) each having a circular or elliptical shape in cross section and a maximum cross sectional diameter of 3 to 10 μm may be employed.

The glass cloth has a thickness of generally from 10 to 500 μm and preferably from 15 to 350 μm, at a thickest portion.

The twisting may be plain weaving, twill weaving or satin weaving.

Examples of the materials of the glass fibers include soda glass, borosilicate glass and non-alkaline glass. Of them, non-alkaline glass is preferably used in view of the possibility that the alkaline component may cause undesirable effects to a TFT or the like.

A method of manufacturing a resin sheet of the present invention is not necessarily limited to a specific method; and a hitherto known prepreg manufacturing method, which, for example, involves impregnating the glass cloth with a resin and then subjected the same to a heat treatment or a UV radiation treatment. Specifically, a resin sheet may be manufactured by the following steps.

For example, a liquid resin is applied onto a flat plate die and then glass cloth is placed thereon, thereby impregnating the glass cloth with the resin. Then, it is subjected to, for example, a heat treatment, a UV radiation or the like, thereby curing the resin so that a cured resin layer containing glass cloth can be formed.

A cured resin layer containing glass cloth may be formed by immersing glass cloth in a liquid resin (immersing step), then allowing the resin to be impregnated in the mesh of the glass cloth, then placing the glass cloth on a flat plate die or the like, and then subjecting it to a heat treatment or a UV radiation treatment. An endless belt or a plastic film may be used in place of the flat plate die. The immersing step may be carried out at ordinal temperature, but is carried out preferably under a condition of a reduced pressure, since a resin is easy to be impregnated in the mesh of the glass cloth under a condition of a reduced pressure.

A resin applied or the like may be subjected to a curing treatment such as a heat treatment or a light radiation treatment according to needs and circumstances. In a case where an epoxy resin, which includes a dicyclopentadiene epoxy resin, is used, preferable conditions are, for example, at a temperature of 100 to 200° C. and a period of 10 minutes to 5 hours, although no limitation is intended.

In a case where an epoxy resin is used as a resin for forming a cured resin material, the epoxy resin may be dispersed or dissolved in a solvent, thereby providing an epoxy resin liquid for use. Examples of the solvent for use include without limitation methyl ethyl ketone, acetone, methyl isobutyl ketone, toluene, xylene and ethyl acetate. The different resins, various types of additives, etc., as mentioned above, may be appropriately added to an epoxy resin liquid kept in a liquid form or an epoxy resin liquid with an epoxy resin dissolved in a solvent.

In a case where the resin sheet is a laminated body including a hard-coat layer, it may be formed by, for example, first forming a hard-coat layer on a flat plate die, then placing glass cloth on the hard-coat layer and then forming a cured resin layer in the manner mentioned above. A laminated body may also be formed by first forming a hard-coat layer on an endless belt of such as stainless steel or on a base, and then laying the hard-coat layer on a cured resin layer with glass cloth embedded therein.

Examples of the method of forming the hard-coat layer include without limitation a method which involves mixing a forming-material as mentioned above in a solvent, thereby preparing a coating liquid, then applying it on a base, and then curing the same by air-drying, heat-curing or UV radiation. Examples of the coating method include without limitation a roll coat method, a spin coat method, a wire bar coat method, a dip coat method, an extrusion method, a curtain coat method, a spray coat method and other hitherto known methods.

A resin sheet including a gas barrier layer may be manufactured by, for example, first forming a gas barrier layer on the hard-coat layer formed in the manner as mentioned above, and then forming a cured resin layer with glass cloth contained therein in the manner as mentioned above. A method of forming the gas barrier layer is not limited to a specific method, but hitherto known methods may be appropriately employed.

Examples of the polarizing plate include a polarizing plate formed by impregnating polyvinyl alcohol with iodine and stretching the same to have a polarizer, on which a protection film is laid, and a polarizing plate thus formed, on which a compensating plate, a tackifier, an antireflection film, a diffusion film and the like are laminated.

Examples of a method of laminating the resin sheet and a polarizing plate include a method which involves laminating them by the use of a tackifier or adhesive or fixing them by the use of a jig such as a metal frame. It is not necessary to have the resin sheet in contact with a polarizing plate, provided that they are held in a laminated state and therefore they may be laminated together with any layer (e.g., an air layer) interposed therebetween.

Lamination of a resin sheet and a polarizing plate may be made any time in a process of manufacturing a display device such as a liquid crystal cell having a laminated film of the present invention, as long as it is made after any step during which a polarizing plate may be damaged by heat or solvent.

A laminated film of the present invention may be used for various applications, and, for example, may be used as a laminated body of a substrate and a polarizing plate in a liquid crystal display device, an EL display device, etc.

Meanwhile, a liquid crystal display device generally includes a laminated body of a liquid crystal cell substrate for supporting liquid crystal and a polarizing plate on each of a visible side and a non-visible side, and a reflector or a backlight on the non-visible side.

A laminated film of the present invention may be used as a laminated body of a liquid crystal cell substrate and a polarizing plate disposed on a visible side or non-visible side, of the thus arranged liquid crystal display device.

In the present invention, for a laminated film used as a laminated body made up of a liquid crystal cell substrate and a polarizing plate disposed on a visible-side of a liquid crystal display device, a light diffusion plate, an anti-glare layer, an antireflection film, a protection layer or a protection plate may be laminated on the polarizing plate. Or, an optical element such as a compensating retardation plate may be laminated between a cured resin layer and a polarizing plate.

The EL display device is generally made up of a transparent electrode, an organic luminant layer that contains an illuminant (an organic electro luminescence illuminant) and a metal electrode, those being laminated in this order on the back side of a transparent substrate, (a substrate for an EL display) and further a polarizing plate and a retardation plate laminated between the transparent substrate and the transparent electrode in the order from the transparent substrate side.

A laminated film of the present invention may be used as a laminated body of a transparent substrate and a polarizing plate in the thus arranged EL display device.

### EXAMPLES

### Example 1

An epoxy resin composition was prepared by stirring and mixing: as resin, 27 parts by weight (hereinafter referred only to parts) of 3,4-epoxycyclohexylmethyl-3,4-epoxycyclohexane carboxylate represented by the aforesaid formula (2) and 73 parts of a bisphenol A type epoxy resin (AER250, trade name (epoxy equivalent of 190); manufactured by Asahi Kasei Corporation) represented by the aforesaid formula (1); as a curing agent, 108 parts of methylhexahydrophthahc anhydride represented by the following formula (6); and as a curing accelerator, 3.75 parts of tetra-n-butylphosphonium o,o-diethylphosphorodithioate represented by the following formula (7).

Then, the above epoxy resin composition was impregnated into glass cloth (“WLT116F”, trade name; manufactured by Nitto Boseki Co., Ltd.) using glass having a refractive index of 1.53, and left to stand for 10 minutes under a condition of a reduced pressure (200 Pa).

Then, a coating liquid, which was prepared by dissolving 17 parts of urethane acrylate represented by the following formula (8) and 5 parts of a photo initiator (“Irgacure 184”, trade name; manufactured by Ciba Specialty Chemicals) in 100 parts of toluene, was applied on a glass plate by a wire bar coat method, then air-dried, and then cured by using a UV curing device. The curing was made under conditions of at 200 mJ/cm² for 1 minute, using a high-pressure mercury vapor lamp. Thus, a hard-coat layer having a film thickness of 2 μm was formed. Then, the glass cloth with the epoxy resin composition impregnated thereinto was laid on the hard-coat layer; this was heated at 120° C. for 1 hour, at 150° C. for 30 minutes and at 180° C. for 30 minutes in a stepwise manner to cure the epoxy resin composition, thereby forming a cured resin layer; and then the cured resin layer was removed from the glass plate. Thus, a resin sheet having a thickness of 100 μm was obtained.

The cured resin layer of the thus obtained resin sheet had a refractive index of 1.53.

This resin sheet was cut into a rectangular shape having weft yarn of glass cloth oriented at an angle of 45 degrees relative to the long side. A polarizing plate, which is provided with a tackifier and has been cut into a rectangular shape having an absorption axis oriented at an angle of 45 degrees relative to the long side, was laid on the thus cut resin sheet with the long side of the resin sheet positioned along the long side of the polarizing plate, so that a laminated film of Example 1 having the weft yarn of the glass cloth oriented at an angle of 0 degree relative to the absorption axis of the polarizing plate was obtained.

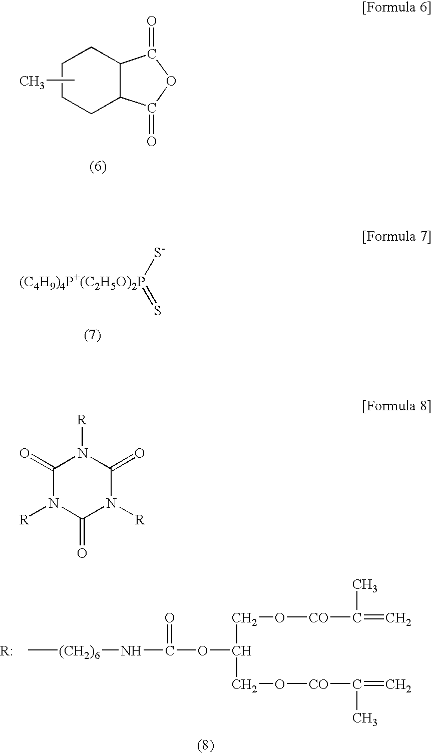

### Example 2

A laminated film of Example 2, which has weft yarn of glass cloth oriented at an angle of 3 degrees relative to an absorption axis of a polarizing plate, was obtained in the same manner as Example 1, except that the polarizing plate with a tackifier was cut into a rectangular shape to have an absorption axis oriented at an angle of 48 degrees relative to the long side.

### Example 3

A laminated film of Example 3, which has weft yarn of glass cloth oriented at an angle of 5 degrees relative to an absorption axis of a polarizing plate, was obtained in the same manner as Example 1, except that the polarizing plate with a tackifier was cut into a rectangular shape to have an absorption axis oriented at an angle of 50 degrees relative to the long side.

### Comparative Example 1

A laminated film of Comparative Example 1, which has weft yarn of glass cloth oriented at an angle of 8 degrees relative to an absorption axis of a polarizing plate, was obtained in the same manner as Example 1, except that the polarizing plate with a tackifier was cut into a rectangular shape to have an absorption axis oriented at an angle of 53 degrees relative to the long side.

### Comparative Example 2

A laminated film of Comparative Example 2, which has weft yarn of glass cloth oriented at an angle of 10 degrees relative to an absorption axis of a polarizing plate, was obtained in the same manner as Example 1, except that the polarizing plate with a tackifier was cut into a rectangular shape to have an absorption axis oriented at an angle of 55 degrees relative to the long side.

### Comparative Example 3

A laminated film of Comparative Example 3, which has weft yarn of glass cloth oriented at an angle of 45 degrees relative to an absorption axis of a polarizing plate, was obtained in the same manner as Example 1, except that the polarizing plate with a tackifier was cut into a rectangular shape to have an absorption axis oriented at an angle of 0 degree relative to the long side.

### Comparative Example 4

A laminated film of Comparative Example 4 was obtained in the same manner as Example 1, except that a resin sheet containing no glass cloth was formed by applying an epoxy resin composition used in Example 1 to a glass plate on which a hard-coat layer was formed by the method of Example 1 to allow the applied epoxy resin composition to have a thickness of 100 μm.

### Test Example

Another polarizing plate was laid on a side of each of the Examples and the Comparative Examples, on which the corresponding polarizing plate is not laminated, to have an absorption axis oriented at an angle of 90 degrees relative to the absorption axis of the said corresponding polarizing plate to have each test piece, whose light transmittance (orthogonal transmittance) was measured by a spectrophotometer, and the presence or absence of light leakage was visually observed and evaluated as “◯” (absence) and “×” (presence).

The coefficient of linear expansion of each of the laminated films of the Examples and the Comparative Examples was measured by the TMA method.

The respective results are shown in Table 1 below.

TABLE 1

| | ANGLE | | | |
|---|---|---|---|---|
| | BETWEEN | | | |
| | WEFT YARN | | | |
| | AND | TRANSMITTANCE | | COEFFICNENT |
| | ABSORPTION | (ORTHOGONAL | LIGHT | OF LINEAR |
| | AXIS | TRANSMITTANCE) | LEAKAGE | EXPANSION |
| EXAMPLE 1 | 0 DEG. | 0.02 | ◯ | 12 × 10⁻⁶/° C. |
| EXAMPLE 2 | 3 DEG. | 0.03 | ◯ | 12 × 10⁻⁶/° C. |
| EXAMPLE 3 | 5 DEG. | 0.04 | ◯ | 12 × 10⁻⁶/° C. |
| COMPARATIVE | 8 DEG. | 0.05 | X | 12 × 10⁻⁶/° C. |
| EXAMPLE 1 | | | | |
| COMPARATIVE | 10 DEG. | 0.06 | X | 12 × 10⁻⁶/° C. |
| EXAMPLE 2 | | | | |
| COMPARATIVE | 45 DEG. | 0.30 | X | 12 × 10⁻⁶/° C. |
| EXAMPLE 3 | | | | |
| COMPARATIVE | — | 0.02 | ◯ | 75 × 10⁻⁶/° C. |
| EXAMPLE 4 | | | | |

As being apparent from Table 1, test pieces using the laminated films of Examples 1 to 3 each cause light leakage of such a level as not to be visually recognized, with an orthogonal transmittance of 0.04 or less, so that advantages associated with the use of glass cloth, namely low coefficient of thermal expansion and reduction in light leakage are seen. Meanwhile, a test piece using the laminated film of Comparative Example 3 showed a higher transmittance than that of Comparative Example 2, and had excessive light leakage. Thus, it is anticipated that when a liquid crystal display device is fabricated by using the laminated film of Comparative Example 3, lowering of the contrast may be caused.

It is recognized that a laminated film of Comparative Example 4 has a higher coefficient of linear expansion and therefore shows instability in size. Although the laminated film of Comparative Example 1 has an orthogonal transmittance different only by 0.01 from that of the laminated film of Example 3, there is a great difference therebetween on the light leakage based on visual observation, in which light leakage was not visually observed at all for the laminated film of Example 3, while light leakage was clearly visually recognized for the laminated film of Comparative Example 1. The laminated film of Comparative Example 2 had an orthogonal transmittance of 0.06 and stronger light leakage than the light leakage for Comparative Example 1 was visually recognized.

1. A laminated film, comprising a resin sheet having a cured resin layer containing glass cloth and a polarizing plate laminated on the resin sheet, in which any one of weft yarn and warp yarn of the glass cloth is oriented at an angle of 5 degrees or less relative to an absorption axis of the polarizing plate.

2. A laminated film according to claim 1, wherein the glass cloth is embedded in a cured resin material that forms the cured resin layer.

3. A laminated film according to claim 1, wherein the resin sheet includes a hard-coat layer that is harder than the cured resin layer.

4. A laminated film according to claim 1, wherein the resin sheet includes a gas barrier layer that has higher gas barrier property than the cured resin layer.

5. A liquid crystal cell display device comprising the laminated film according to claim 1.

6. An image display device comprising the laminated film according to claim 1.
